(19) United States
(12) Patent Application Publication
(10) Pub. No.: US 2024/0233172 A1
(43) Pub. Date: Jul. 11, 2024

(54) VIDEO PROCESSING METHOD AND DEVICE, AND ELECTRONIC DEVICE

(71) Applicant: Beijing Zitiao Network Technology Co., Ltd., Haidian District, Beijing (CN)

(72) Inventors: Hengkai GUO, Beijing (CN); Jiawei WEN, Beijing (CN)

(21) Appl. No.: 18/558,130

(22) PCT Filed: Mar. 17, 2022
(86) PCT No.: PCT/CN2022/081547

§ 371 Date: Oct. 30, 2023

(30) Foreign Application Priority Data
Apr. 30, 2021 (CN) 202110485704.2

(51) Int. Cl. G06T 7/73; G06T 7/11; G06T 7/50

(52) U.S. Cl. CPC G06T 7/73; G06T 7/11; G06T 7/50; G06T 2207/10016; G06T 2207/30244

(57) ABSTRACT

Embodiments of the present disclosure provide a video processing method and device, and an electronic device. The method includes: acquiring a first video frame to be processed; segmenting the first video frame to acquire a patch corresponding to a target object and a patch region; acquiring position information of three-dimensional points within the patch region, and determining, according to the position information of the three-dimensional points within the patch region, three-dimensional position information of the patch; displaying, based on the three-dimensional position information of the patch, the patch at a position corresponding to at least one second video frame.

### CROSS-REFERENCE TO RELATED APPLICATIONS

This application is a national stage of International Application No. PCT/CN2022/081547, filed on Mar. 17, 2022, which claims priority to Chinese Patent Application No. 202110485704.2, entitled “Video Processing Method and Device, and Electronic Device”, and filed with the China National Intellectual Property Administration on Apr. 30, 2021. The disclosures of the aforementioned applications are hereby incorporated by reference in their entireties.

### TECHNICAL FIELD

The present disclosure relates to the field of video processing technologies, and in particular, to a video processing method and device, an electronic device, a storage medium, a computer program product, and a computer program.

### BACKGROUND

Image segmentation refers to the technique and process of dividing an image into several specific and distinctive regions and extracting a target object of interest.

At present, after a region where the target object is located, i.e., a segmented region, is determined by means of image segmentation, only two-dimensional position information, i.e., two-dimensional coordinates, of the segmented region can be determined, and corresponding three-dimensional position information cannot be determined, resulting in poor diversity of user's interaction operations implemented by means of an image segmentation method. Therefore, there is an urgent need for a method for determining three-dimensional position information of a region where a target object is located, i.e., a segmented region, to enrich user's video editing operations and improve user's interestingness.

### SUMMARY

Embodiments of the present disclosure provide a video processing method and device, an electronic device, a storage medium, a computer program product, and a computer program, so as to solve the problem in the prior art that three-dimensional position information of a segmented region cannot be determined.

In a first aspect, an embodiment of the present disclosure provides a video processing method, including:
acquiring a first video frame to be processed;
segmenting the first video frame to acquire a patch corresponding to a target object and a patch region;
acquiring position information of three-dimensional points within the patch region, and determining, according to the position information of the three-dimensional points within the patch region, three-dimensional position information of the patch;
displaying, based on the three-dimensional position information of the patch, the patch at a position corresponding to at least one second video frame.

In a second aspect, an embodiment of the present disclosure provides a video processing device, including:
an information acquisition module, configured to acquire a first video frame to be processed;
a processing module, configured to segment the first video frame to acquire a patch corresponding to a target object and a patch region;
where the processing module is configured to acquire position information of three-dimensional points within the patch region, and determine, according to the position information of the three-dimensional points within the patch region, three-dimensional position information of the patch;
a displaying module, configured to display, based on the three-dimensional position information of the patch, the patch at a position corresponding to at least one second video frame.

In a third aspect, an embodiment of the present disclosure provides an electronic device, including at least one processor and a memory,
where the memory stores computer execution instructions;
the at least one processor executes the computer execution instructions, causing the at least one processor to perform the video processing method of the first aspect and various possible designs of the first aspect.

In a fourth aspect, an embodiment of the present disclosure provides a computer readable storage medium, where the computer readable storage medium stores therein computer execution instructions, when the computer execution instructions are executed by a processor, the video processing method of the first aspect and various possible designs of the first aspect is implemented.

In a fifth aspect, an embodiment of the present disclosure provides a computer program product including a computer program, where when the computer program is executed by a processor, the video processing method of the first aspect and various possible designs of the first aspect is implemented.

In a sixth aspect, an embodiment of the present disclosure provides a computer program, where when the computer program is executed by a processor, the video processing method of the first aspect and various possible designs of the first aspect is implemented.

Embodiments of the present disclosure provide a video processing method and device, an electronic device, a storage medium, a computer program product, and a computer program. The method includes: acquiring a first video frame to be processed; segmenting the first video frame to acquire a patch corresponding to a target object and a patch region; acquiring position information of three-dimensional points within the patch region, and determining, according to the position information of the three-dimensional points within the patch region, three-dimensional position information of the patch; displaying, based on the three-dimensional position information of the patch, the patch at a position corresponding to at least one second video frame. According to embodiments of the present disclosure, when a first video frame of a to-be-processed video is acquired, image segmentation is performed on the first video frame to extract a target object from the first video frame, so as obtain a patch corresponding to the target object, a region where the target object is located, i.e., a segmented region, is determined, and it is determined same as the patch region. Position information of three-dimensional points in a patch region is determined, where the position information of the three-dimensional points is three-dimensional position information; and based on the three-dimensional position information of the three-dimensional points, three-dimensional position information of the patch is obtained, so as to obtain three-dimensional position information of the patch region, i.e., a segmented region, corresponding to the patch, thereby achieving the determination of three-dimensional position information of the segmented region. Furthermore, after three-dimensional position information of the patch corresponding to the target object is obtained, the patch is placed as a virtual object at a position in the space corresponding to the three-dimensional position information, thereby achieving the freeze-frame effect of the target object, enriching the user's video editing operations, increasing interestingness, and improving user's experience.

### BRIEF DESCRIPTION OF DRAWINGS

To describe the technical solutions in the embodiments of the present disclosure or in the prior art more clearly, the drawings required for describing the embodiments or the prior art will be briefly introduced in the following. Obviously, the drawings in the following description are some embodiments of the present disclosure, for persons of ordinary skill in the art, other drawings may also be obtained according to these drawings without creative effort.

FIG. 1 is a schematic diagram of a scenario of a video processing method provided by an embodiment of the present disclosure.

FIG. 2 is a flowchart I of a video processing method provided by an embodiment of the present disclosure.

FIG. 3 is a schematic diagram of image segmentation provided by an embodiment of the present disclosure.

FIG. 4 is a schematic diagram of person movement provided by an embodiment of the present disclosure.

FIG. 5 is a schematic diagram of person freeze-frame provided by an embodiment of the present disclosure.

FIG. 6 is a flowchart II of a video processing method provided by an embodiment of the present disclosure.

FIG. 7 is a schematic diagram of spatial three-dimensional points provided by an embodiment of the present disclosure.

FIG. 8 is a structural block diagram of a video processing device provided by an embodiment of the present disclosure.

FIG. 9 is a schematic diagram of a hardware structure of an electronic device provided by an embodiment of the present disclosure.

### DESCRIPTION OF EMBODIMENTS

In order to make objects, technical solutions and advantages of the embodiments of the present disclosure clearer, the technical solutions in the embodiments of the present disclosure will be described clearly and completely in combination with the accompanying drawings of the embodiments of the present disclosure. Apparently, the described embodiments are a part rather than all of the embodiments of the present disclosure. All other embodiments obtained by persons of ordinary skill in the art based on the embodiments of the present disclosure without creative effort shall belong to the scope of protection of the present disclosure.

In the prior art, after a region where the target object is located, i.e., a segmented region, is determined by means of image segmentation, only two-dimensional position information, i.e., 2D position coordinates, of the segmented region can be determined, and corresponding three-dimensional position information cannot be determined. Therefore, there is an urgent need for a method for determining three-dimensional position information of a region where a target object is located, i.e., a segmented region.

Therefore, in view of the described problem above, the technical concept of the present disclosure is, determining, based on the use of image segmentation in combination with three-dimensional points within the segmented region determined by a simultaneous localization and mapping (SLAM) algorithm, a segmented region, i.e., three-dimensional position information, i.e., 3D position coordinates, of a patch corresponding to the segmented region, thereby achieving the determination of three-dimensional position information of the segmented region; and after the three-dimensional position information of the segmented region is determined, placing, based on the three-dimensional position information, a patch corresponding to the segmented region, i.e., a patch corresponding to a target object, as a virtual object at a corresponding position in the space, thereby achieving the freeze-frame effect of the target object, and increasing interestingness.

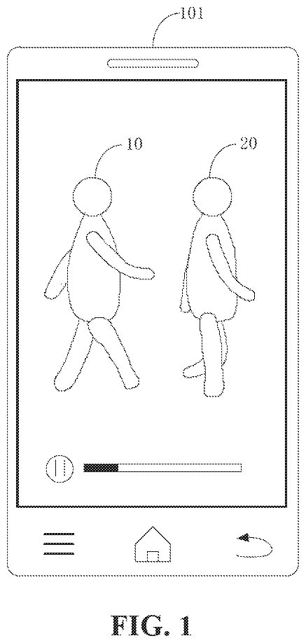

FIG. 1 is a schematic diagram of a scenario of a video processing method provided by an embodiment of the present disclosure. As shown in FIG. 1, during a process of shooting a video, an electronic device 101 determines three-dimensional (3D) position coordinates of a target object in a video frame obtained by shooting or a video frame in a video that has been shot completely, so as to place a patch corresponding to the target object at a position corresponding to the 3D position coordinates and achieve the freeze-frame of the target object, so that a frame of picture of a finally obtained video may include a plurality of target objects. For example, in FIG. 1, a person 10 is a target object, i.e., the person at the previous time, i.e., a person-shaped sign corresponding to the posture of a person in the previous video frame, which is a virtual object, and a person 20 is an actual user image of the person at the current moment, i.e., the current video frame, which is not a virtual object.

The electronic device 101 may be a mobile terminal, a computer device (such as a desktop computer, a notebook computer, and an all-in-one PC), and the mobile terminal may include a mobile device with data processing capabilities such as a smart phone, a hand-held computer, and a tablet computer.

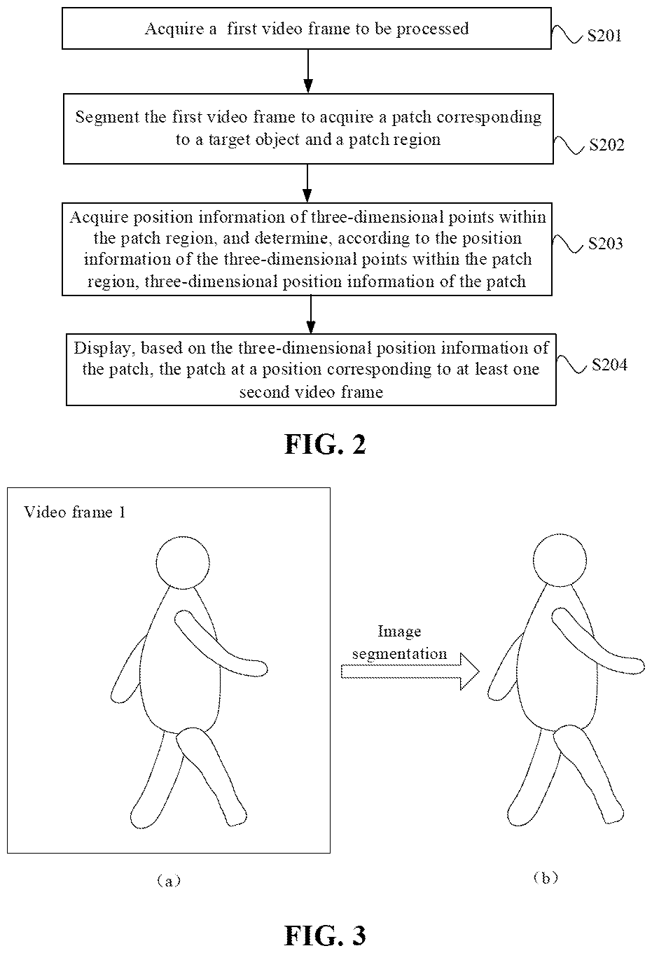

Referring to FIG. 2, FIG. 2 is a flowchart I of a video processing method provided by an embodiment of the present disclosure. The method in this embodiment may be applied to an electronic device, specifically, applied to a processing apparatus on the electronic device. The video processing method includes the following.

S201: acquire a first video frame to be processed.

In an embodiment of the present disclosure, when a user wants to publish or shoot a video, an application on an electronic device may be opened, the application displays a page for shooting the video, and the page is used for displaying a shot object. A video generally consists of a plurality of frames of pictures. Therefore, in the process of shooting the video, a first device acquires a video frame obtained by shooting, i.e., a frame of picture, in real time. When it is determined that a freeze-frame effect needs to be added, i.e., a certain shot object needs to be freeze-framed, a video frame obtained by shooting is used as a first video frame, i.e., a first video frame to be processed.

In addition, the first video frame may also be a video frame in a video that has been shot completely, for example, the first video frame is a video frame in a video uploaded by a user, i.e., when the user wants to add a freeze-frame effect to a certain video, the video can be uploaded; and when the video is acquired by the electronic device, the video frame in the video is used as a first video frame to be processed, i.e., a first video frame.

The application may be an application that publishes a video, and may also be another application that can shoot a video, which is not limited in the present disclosure.

In an implementation, the following several triggering manners can be used for determining whether a freeze-frame effect needs to be added.

One manner is to acquire the first video frame in response to a triggering operation acting on a screen of an electronic device.

Specifically, if it is detected that a user inputs a triggering operation on a screen of an electronic device, it is indicated that a freeze-frame effect needs to be added, i.e., a patch corresponding to a target object needs to be added to a video, a first video frame is acquired, i.e., a video frame obtained by current shooting or a video frame in a currently played video that has been shot completely is acquired, so that the patch corresponding to the target object is added to the corresponding second video frame.

In an implementation, the triggering operation includes a triggering operation such as a click operation and a slide operation.

Another manner is to acquire the first video frame when detecting that the target object is in a static state.

Specifically, in a process of shooting a video or playing a video that has been shot completely, when it is detected that a target object in the video is in a static state, i.e., stationary, a video frame that is shot currently or played currently may be acquired and determined as the first video frame.

A further manner is to acquire the first video frame at a preset interval.

Specifically, in a process of shooting a video or playing a video that has been shot completely, at a preset interval, a video frame that is shot currently or played currently may be acquired and determined as the first video frame.

The preset interval may be set by default or user-defined. In addition, the target object may also be set by default or user-defined, for example, the target object is a person, which is not limited in the present disclosure.

It may be understood that the foregoing several triggering manners are merely examples, and may also be determined by using other triggering manners. For example, when it is detected that a target object in a shooting page inputs an interaction action (for example, a five-finger opening action), it is indicated that a freeze-frame effect needs to be added, and then a first video frame is acquired.

S202: segment the first video frame to acquire a patch corresponding to a target object and a patch region.

In the embodiments of the present disclosure, after the first video frame is obtained, the image segmentation is performed on the first video frame to extract a target object, i.e., a patch corresponding to the target object, from the first video frame, and it is determined a region where the target object in the first video frame is located so as to obtain the patch region, i.e., a segmented region.

The patch corresponding to the target object represents a planar picture of the target object. For example, a target object is a person, and image segmentation is performed on a video frame 1 as shown in (a) of FIG. 3 to extract a person in the video frame 1, so as to obtain a patch corresponding to the person, in which the patch corresponding to the person represents a planar picture of the person, which is equivalent to a person-shaped sign as shown in (b) of FIG. 3.

In addition, when the image segmentation is performed on the first video frame, the position information of the region where the target object is located, i.e., the patch region, may also be obtained, and the position information is two-dimensional position information.

The position information of the patch region includes position information of a target point corresponding to the patch region and/or position range information corresponding to the patch region, i.e., a coordinate range included in the patch region.

The coordinate range includes a coordinate range on a first coordinate axis (for example, an X axis), i.e., a first coordinate range, and a coordinate range on a second coordinate axis (for example, a Y axis), i.e., a second coordinate range.

Further, the position range information corresponding to the patch region may be determined according to the coordinates of vertexes, i.e., edge points, of the patch region, and may also be determined by other existing manners. The position information of the target point represents two-dimensional position information, i.e., 2D position coordinates, of the target point in a camera coordinate system.

S203: acquire position information of three-dimensional points within the patch region, and determine, according to the position information of the three-dimensional points within the patch region, three-dimensional position information of the patch.

In the embodiments of the present disclosure, after the patch region in the first video frame is determined, the position information of the three-dimensional points within the patch region is determined, i.e., the position information of the three-dimensional points in the actual environment corresponding to the patch region is determined. Based on the position information of the three-dimensional points within the patch region, and in combination with position information, i.e., two-dimensional position information, of the patch region, three-dimensional position information of the patch, i.e., three-dimensional position information of the patch region, is obtained, thereby achieving the determination of the three-dimensional position of the patch region.

In an implementation, the position information of the three-dimensional points is three-dimensional position information, i.e., 3D position coordinates, of the three-dimensional points, and includes depths corresponding to the three-dimensional points.

The depths corresponding to the three-dimensional points represent a distance between the three-dimensional point and the camera, i.e., an optical center of the camera, which is equivalent to a coordinate value of the three-dimensional point on the Z axis.

S204: display, based on the three-dimensional position information of the patch, the patch at a position corresponding to at least one second video frame.

In the embodiments of the present disclosure, after the three-dimensional position information of the patch corresponding to the target object, i.e., the 3D position coordinates of the patch region, is obtained, the patch corresponding to the target object is placed at a position on the second video frame corresponding to the 3D position coordinates, i.e., the patch corresponding to the target object is displayed at the position, which is equivalent to that the target object is freeze-framed at a certain spatial position, thereby achieving the freeze-frame effect of the target object.

The second video frame is a video frame that includes 3D position coordinates of a patch region in a world coordinate system in a video to which the first video frame belongs, i.e., the second video frame is a video frame that includes a position of a target object in the first video frame, and the second video frame and the first video frame belong to the same video.

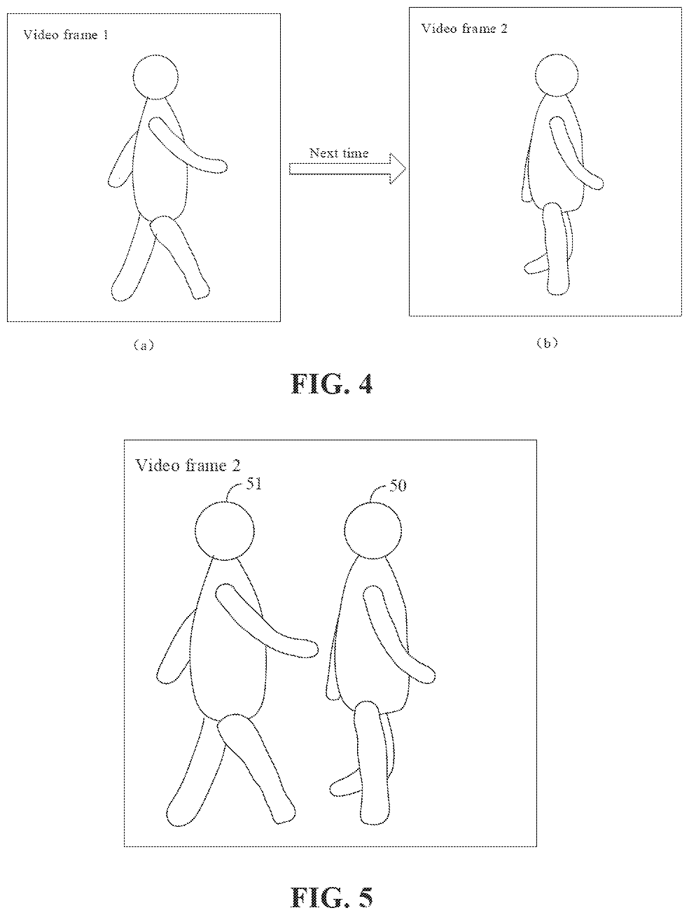

Taking a specific application scenario as an example, in a process in which a user shoots a video that includes a target object, i.e., a person, the person is moving, and a video frame 1 as shown in (a) in FIG. 4 and a video frame 2 as shown in (b) in FIG. 4 are obtained in sequence. When the person in the video frame 1 is freeze-framed, it indicates that the current posture of the person needs to be freeze-framed, i.e., the patch of the person in the video frame 1 is placed at a corresponding position in the space as a virtual object. Since the video frame 2 includes a position where a person in the video frame 1 is located, the obtained video frame 2 includes an actual person (such as a person 50 in FIG. 5) and a patch of the person (such as a person 51 in FIG. 5) in the video frame 1, which is equivalent to constantly enabling the posture of the person at the current moment to form a person-shaped sign during the walking of the person, and place same at a corresponding position.

In the embodiments of the present disclosure, after the image segmentation is performed on the first video frame, the patch and the patch region corresponding to the target object are obtained; based on 3D position coordinates of three-dimensional points within the patch region, the patch region, i.e., a 3D position of the patch, is determined, so as to place the patch as a virtual object in a space by means of the 3D position of the patch, thereby changing the result of image segmentation from 2D to 3D patch, and achieving segmentation and freeze-frame of a target object.

It can be seen from the above description that when a first video frame of a to-be-processed video is acquired, the image segmentation is performed on the first video frame to extract a target object from the first video frame, so as obtain a patch corresponding to the target object, it is determined a region where the target object is located, i.e., the patch region. It is determined position information of three-dimensional points in a patch region, where the position information of the three-dimensional points is three-dimensional position information; and based on the three-dimensional position information of the three-dimensional points, three-dimensional position information of the patch is obtained, so as to obtain three-dimensional position information of the patch region, i.e., the region where the target object is located, corresponding to the patch, thereby achieving the determination of three-dimensional position information of the region where the target object is located, i.e., the segmented region. Furthermore, after three-dimensional position information of the patch corresponding to the target object is determined, the patch can be placed at a position corresponding to the three-dimensional position information, thereby achieving the freeze-frame effect of the target object, enriching the user's video editing operations, increasing interestingness, and improving user's experience.

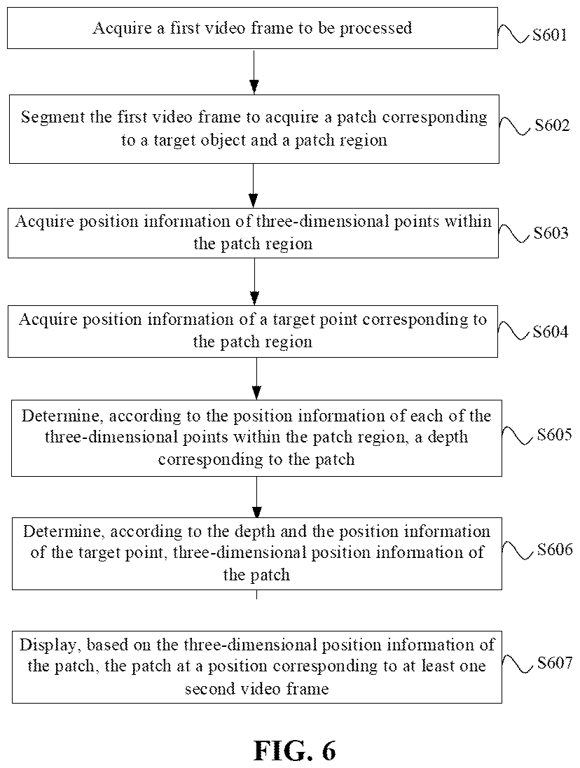

Referring to FIG. 6, FIG. 6 is a flowchart II of a video processing method provided by an embodiment of the present disclosure. In this embodiment, a process of determining three-dimensional position information of a patch corresponding to a target object is described in detail. The video processing method includes:
S601: acquire a first video frame to be processed.
S602: segment the first video frame to acquire a patch corresponding to a target object and a patch region;
S603: acquire position information of three-dimensional points within the patch region.

In the embodiments of the present disclosure, the three-dimensional points in the patch region may be determined by means of a simultaneous localization and mapping construction algorithm, i.e., it is determined, based on the synchronous positioning and map construction algorithm, position information of spatial three-dimensional points in the first video frame and each of the spatial three-dimensional points. It is determined, according to the position information of the spatial three-dimensional points, spatial three-dimensional points within the patch region from the spatial three-dimensional points. The position information of the spatial three-dimensional points within the patch region is taken as the position information of the three-dimensional points within the patch region.

In the embodiments of the present disclosure, a first video frame is processed by means of an SLAM algorithm, so as to obtain position information of three-dimensional points, i.e., spatial three-dimensional points and each of the three-dimensional points, in an actual space environment corresponding to the first video frame of a to-be-processed video, and the position information of the three-dimensional points are determined as position information of the spatial three-dimensional points. According to the position information of the spatial three-dimensional points, spatial three-dimensional points belonging to the patch region is screened from all the spatial three-dimensional points, the screened spatial three-dimensional points is taken as the three-dimensional points within the patch region, and accordingly, the position information of the screened spatial three-dimensional points is taken as the position information of the three-dimensional points within the patch region.

Further, in an implementation, when the spatial three-dimensional points belonging to the patch region are screened from all the spatial three-dimensional points according to the position information of the spatial three-dimensional points, the position range information corresponding to the patch region, i.e., the coordinate range included in the patch region, needs to be used. For each of the spatial three-dimensional points, a first coordinate and a second coordinate of the spatial three-dimensional point is acquired, and if the first coordinate and the second coordinate are both within a coordinate range included in the patch region, the spatial three-dimensional point is determined as a spatial three-dimensional point belonging to the patch region.

The first coordinate represents a coordinate of the spatial three-dimensional point on a first coordinate axis, and the second coordinate represents a coordinate of the spatial three-dimensional point on a second coordinate axis. When the first coordinate of the spatial three-dimensional point belongs to a first coordinate range corresponding to the patch region, and the second coordinate belongs to a second coordinate range, it is determined that the spatial three-dimensional point is a spatial three-dimensional point belonging to the patch region. Otherwise, when the first coordinate of the spatial three-dimensional point does not belong to the first coordinate range corresponding to the patch region, or the second coordinate does not belong to the second coordinate range, it is determined that the spatial three-dimensional point is not a spatial three-dimensional point belonging to the patch region.

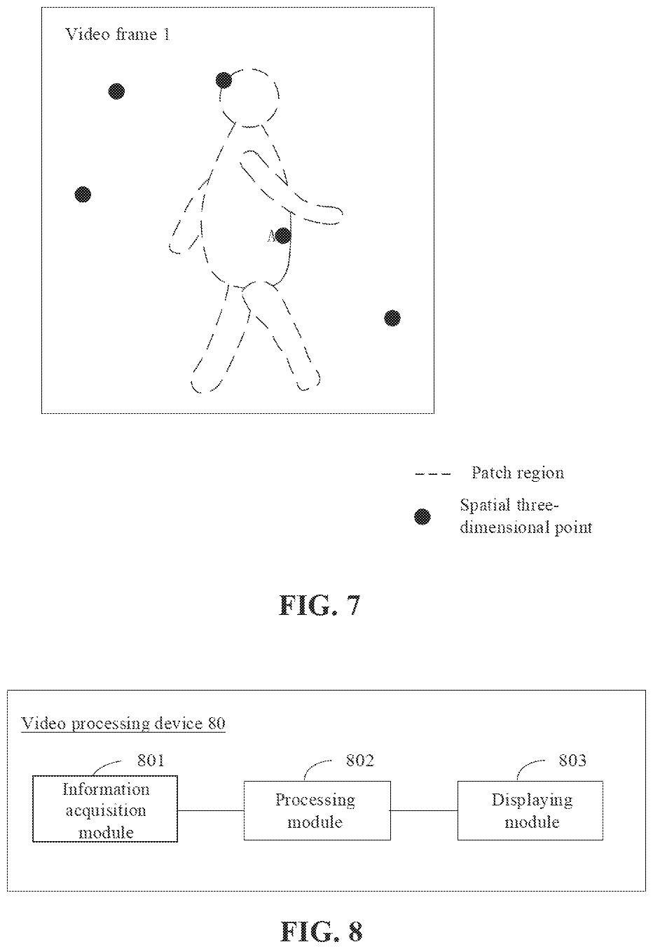

For example, as shown in FIG. 7, a first video frame is processed by means of an SLAM algorithm to determine a plurality of spatial three-dimensional points, where the plurality of spatial three-dimensional points include a spatial three-dimensional point A. The first coordinate range of the patch region includes 100 to 200, and the second coordinate range includes 150 to 220. The first coordinate of the spatial three-dimensional point A is 110, which is within the first coordinate range, and the second coordinate is 160, which is within the second coordinate range; therefore, it is determined that the spatial three-dimensional point A belongs to the patch region.

In addition, in an implementation, a camera pose corresponding to the first video frame may also be determined based on a simultaneous localization and mapping algorithm, i.e., when the first video frame is processed by means of the SLAM algorithm, a camera pose corresponding to the first video frame may also be obtained, so that coordinate system conversion is performed by using the camera pose, i.e., the coordinates in a camera coordinate system is converted into the coordinate in a world coordinate system.

S604: acquire position information of a target point corresponding to the patch region.

In the embodiments of the present disclosure, when the image segmentation is performed on the first video frame, the position information of the target point corresponding to the patch region, i.e., the 2D position coordinates of the target point, can be determined.

In an implementation, the target point includes the center of gravity of patch region. The process of determining, based on image segmentation, the position coordinates of the patch region, i.e., the center of gravity of the segmented region, is an existing process, which will not be described in detail herein.

S605: determine, according to the position information of each of the three-dimensional points within the patch region, a depth corresponding to the patch.

In the embodiments of the present disclosure, after the position information of each of the three-dimensional points within the patch region is obtained, the depth corresponding to the patch region is determined by means of the depth in the position information of each of the three-dimensional points, so as to obtain the depth corresponding to the patch.

The depth corresponding to the patch represents the distance between the patch, i.e., the patch region, and the camera. The depth corresponding to the patch is actually the depth corresponding to the target point corresponding to the patch region, i.e., the distance between the target point and the camera.

In an implementation, when the depth corresponding to the patch is determined, statistical processing may be performed on the depth corresponding to each of the three-dimensional points within the patch region so as to obtain the depth corresponding to the patch, i.e., on the basis of determining the depth corresponding to each of the three-dimensional points within the patch region, the depth corresponding to the patch region is determined so as to obtain the depth corresponding to the patch.

Further, in an implementation, when statistics processing is performed on the depth corresponding to each of the three-dimensional points in the patch region so as to obtain the depth corresponding to the patch, the depth corresponding to the patch may be determined in the following statistics manners.

One manner is to acquire a median of depths corresponding to the three-dimensional points within the patch region, and to determine the median as the depth corresponding to the patch.

Specifically, depths respectively corresponding to all three-dimensional points within a patch region are ranked to determine a median of depths respectively corresponding to all three-dimensional points, and the median is determined as the depth corresponding to the patch, i.e., the depth corresponding to the patch region.

In the embodiments of the present disclosure, the depth corresponding to the patch is determined from the depths corresponding to the three-dimensional points within the patch region by using the median, i.e., when the depth corresponding to the center of gravity of the patch is determined, the determined depth is more accurate, and thus when the 3D position coordinates of the patch are determined by using the depth, the difference between the determined 3D position coordinates of the patch and the actual position of the target object corresponding to the patch is small, thereby ensuring the accuracy of position determination.

Another manner is to acquire a mode of depths corresponding to the three-dimensional points within the patch region, and to determine the mode as the depth corresponding to the patch.

Specifically, depths respectively corresponding to all three-dimensional points within a patch region are ranked to determine a mode of depths respectively corresponding to all three-dimensional points, and the mode are determined as the depth corresponding to the patch.

A further manner is to acquire an average value of depths corresponding to the three-dimensional points within the patch region, and to determine the average value as the depth corresponding to the patch.

Specifically, an average value of depths corresponding to the three-dimensional points within the patch region is calculated, and the average value is determined as the depth corresponding to the patch.

It can be understood that, the patch region may also be determined according to the depths corresponding to the three-dimensional points in the patch region, i.e., the depth corresponding to the patch may also be determined in other manners, for example, the maximum value of depths corresponding to the three-dimensional points in the patch region is taken as the depth corresponding to the patch, which is not limited in the present disclosure.

S606: determine, according to the depth and the position information of the target point, three-dimensional position information of the patch.

In the embodiments of the present disclosure, after the position information of the target point is obtained, since the position information of the target point is the 2D position coordinates, the three-dimensional position information of the target point, i.e., the 3D position coordinates, is determined in combination with the depth corresponding to the target point, thereby obtaining the three-dimensional position information of the patch.

In the embodiment of the present disclosure, in an implementation, S606 is implemented as follows:
acquiring a camera pose, and determining, according to the depth, the position information of the target point and the camera pose, three-dimensional position information of the patch in a world coordinate system.

In the embodiments of the present disclosure, since the 3D position coordinates of the patch in the world coordinate system need to be determined when the patch is placed, the 3D position coordinates, i.e., the three-dimensional position information, of the patch in the world coordinate system, need to be determined by means of the camera pose, the depth corresponding to the patch, and the position information of the target point.

Further, in an implementation, the process of determining, according to the camera pose, the depth corresponding to the patch and the position information of the target point, three-dimensional position information of the patch in a world coordinate system includes:
determining, according to the depth and the position information of the target point, first three-dimensional position information corresponding to the target point, where the first three-dimensional position information corresponding to the target point is three-dimensional position information of the target point in a camera coordinate system; converting, according to the camera pose, the first three-dimensional position information of the target point so as to obtain second three-dimensional position information corresponding to the target point, where the second three-dimensional position information corresponding to the target point is three-dimensional position information of the target point in the world coordinate system; and taking the second three-dimensional position information corresponding to the target point as the three-dimensional position information of the patch in the world coordinate system.

In the embodiments of the present disclosure, after the 3D position coordinates, i.e., the first three-dimensional position information, of the target point in the camera coordinate system, is determined by using the position information of the target point and the depth corresponding to the target point, the 3D position coordinates need to be converted by using the camera pose, so as to convert the 3D position coordinates of the target point in the camera coordinate system into the 3D position coordinates of the target point in the world coordinate system, i.e., the second three-dimensional position information.

The position information, i.e., the 2D position coordinates, of the target point is the position coordinates of the target point in the camera coordinate system.

The camera pose includes a rotation matrix and a translation vector. The camera pose is a camera pose corresponding to the first video frame, which can be obtained during the processing of the first video frame by means of the SLAM algorithm. Certainly, the camera pose can also be obtained by processing the first video frame by means of other algorithms, which is not limited herein.

In the embodiments of the present disclosure, when the three-dimensional position information of the patch in the world coordinate system is determined, the camera pose (e.g., rotation matrix and translation vector), internal parameters of the camera, the position information of the target point, i.e., the 2D position coordinates of the target point, the depth corresponding to the target point, and other parameters may be used for the determination. Certainly, the parameters listed above are only examples, and other parameters may also be used to determine the three-dimensional position information of the patch in the world coordinate system, which is not limited in the present disclosure.

It can be understood that, the above manner for determining the three-dimensional position information of the patch in the world coordinate system, i.e., the process of determining the three-dimensional position information of the patch in the world coordinate system by means of the camera pose, the depth corresponding to the patch, and the position information of the target point, is only an example, and the patch, i.e., the three-dimensional position information of the target point in the world coordinate system, may also be determined by means of other manners, which are not limited herein.

S607: display, based on the three-dimensional position information of the patch, the patch at a position corresponding to at least one second video frame.

In the embodiments of the present disclosure, in order to better place the patch corresponding to the target object, the direction of the patch can also be acquired. Based on the three-dimensional position information and the direction of the patch, the patch is displayed a the position corresponding to at least one second video frame, i.e., according to the direction of the patch, the patch is placed at a position corresponding to the three-dimensional position information of the patch, i.e., the patch is placed as a virtual object at the corresponding position in the space, and displayed on the video frame including this position, i.e., the second video frame.

The direction of the patch may be set by default or user-defined. For example, the direction of the patch is a direction being perpendicular to the z-axis of the camera, where the patch is parallel to the camera.

In the embodiments of the present disclosure, when image segmentation is performed on the first video frame to determine a segmented region, i.e., the 2D position coordinates of the target point corresponding to the patch region, the distance between the target point and the camera is determined, i.e., the depth corresponding to the target point is determined. By combining this depth with the 2D position coordinates of the target point, the 3D position coordinates of the target point in the camera coordinate system are obtained; and in combination with the camera pose corresponding to the first video frame, the 3D position coordinates of the target point in the camera coordinate system is converted into the 3D position coordinates of the target point in the world coordinate system, so that the 3D position coordinates of the segmented region are obtained, thereby achieving the determination of the 3D position coordinates of the segmented region.

In the embodiments of the present disclosure, three-dimensional points are determined by means of the SLAM algorithm; and in combination with the 2D position coordinates of the patch region in the first video frame obtained through image segmentation, the 3D position coordinates of the patch region in camera coordinates is determined; the coordinate systems are converted by means of the camera pose so as to obtain the 3D position coordinates of the patch region in world coordinates, i.e., to obtain the actual position of the target object in the world coordinate system at the time corresponding to the first video frame; and the 3D patch is placed at a position in the space corresponding to the 3D position coordinates of the target object in the world coordinate system, so as to display the 3D patch at this position, which is equivalent to freeze-framing the target object at this position, thereby achieving the freeze-frame effect of the target object, and thus enabling the video to present an effect that includes multiple target objects, enriching user's video editing operations, increases user's interestingness, and improving user's satisfaction.

Corresponding to the video processing method of the aforementioned embodiment, FIG. 8 is a structural block diagram of a video processing device provided by an embodiment of the present disclosure. For illustrative purposes, only parts related to the embodiments of the present disclosure are shown. Referring to FIG. 8, a video processing device 80 includes an information acquisition module 801, a processing module 802, and a displaying module 803.

The information acquisition module 801 is configured to acquire a first video frame to be processed.

The processing module 802 is configured to segment the first video frame to acquire a patch corresponding to a target object and a patch region.

The processing module 802 is further configured to acquire position information of three-dimensional points within the patch region, and determine, according to the position information of the three-dimensional points within the patch region, three-dimensional position information of the patch.

The displaying module 803 is configured to display, based on the three-dimensional position information of the patch, the patch at a position corresponding to at least one second video frame.

In one embodiment of the present disclosure, the processing module 802 is further configured to:
acquire position information of a target point corresponding to the patch region;
determine, according to the position information of each of the three-dimensional points within the patch region, a depth corresponding to the patch;
determine, according to the depth and the position information of the target point, three-dimensional position information of the patch.

In one embodiment of the present disclosure, the three-dimensional position information of the patch is three-dimensional position information in a world coordinate system.

The processing module 802 is further configured to:
acquire a camera pose, and determine, according to the depth, the position information of the target point and the camera pose, three-dimensional position information of the patch in a world coordinate system.

In one embodiment of the present disclosure, the processing module 802 is further configured to:
determine, according to the depth and the position information of the target point, first three-dimensional position information corresponding to the target point, where the first three-dimensional position information corresponding to the target point is three-dimensional position information of the target point in a camera coordinate system;
convert, according to the camera pose, the first three-dimensional position information of the target point so as to obtain second three-dimensional position information corresponding to the target point, where the second three-dimensional position information corresponding to the target point is three-dimensional position information of the target point in the world coordinate system;
take the second three-dimensional position information corresponding to the target point as the three-dimensional position information of the patch in the world coordinate system.

In one embodiment of the present disclosure, the position information of the three-dimensional points includes depths corresponding to the three-dimensional points.

The processing module 802 is further configured to:
perform statistical processing on the depth corresponding to each of the three-dimensional points within the patch region so as to obtain the depth corresponding to the patch.

In one embodiment of the present disclosure, the processing module 802 is further configured to: acquire a median of depths corresponding to the three-dimensional points within the patch region, and determine the median as the depth corresponding to the patch;
or,
acquire a mode of depths corresponding to the three-dimensional points within the patch region, and determine the mode as the depth corresponding to the patch;
or,
acquire an average value of depths corresponding to the three-dimensional points within the patch region, and determine the average value as the depth corresponding to the patch.

In one embodiment of the present disclosure, the displaying module 803 is further configured to:
acquire a direction of the patch;
display, based on the three-dimensional position information of the patch and the direction of the patch, the patch at a position corresponding to at least one second video frame.

In one embodiment of the present disclosure, the processing module 802 is further configured to:
determine, based on a simultaneous localization and mapping construction algorithm, position information of spatial three-dimensional points in the first video frame and each of the spatial three-dimensional points;
determine, according to the position information of the spatial three-dimensional points, spatial three-dimensional points within the patch region from the spatial three-dimensional points;
take the position information of the spatial three-dimensional points within the patch region as the position information of the three-dimensional points within the patch region.

In one embodiment of the present disclosure, the processing module 802 is further configured to:
determine, based on a simultaneous localization and mapping construction algorithm, a camera pose corresponding to the first video frame.

In one embodiment of the present disclosure, the information acquisition module 801 is further configured to:
acquire the first video frame in response to a triggering operation acting on a screen of an electronic device,
and/or,
acquire the first video frame when detecting that the target object is in a static state,
and/or,
acquire the first video frame at a preset interval.

The device provided by this embodiment may be used to execute the technical solution of the foregoing method embodiment, and their implementation principles and technical effects are similar, which are not repeatedly described herein in this embodiment.

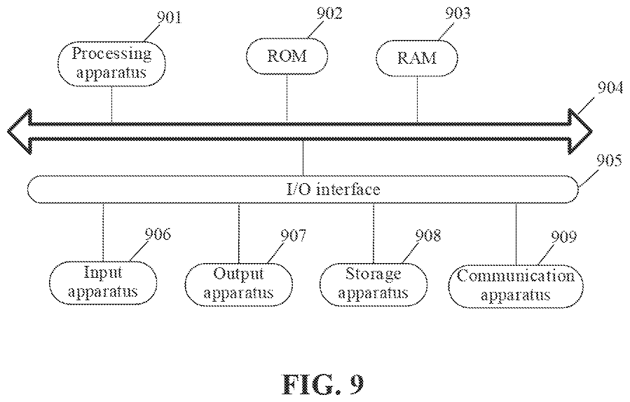

Referring to FIG. 9, a schematic structural diagram of an electronic device 900 suitable for implementing embodiments of the present disclosure is shown. The electronic device 900 can be a terminal device or a server. The terminal device may include, but is not limited to, a mobile terminal such as a mobile phone, a laptop, a digital broadcast receiver, a personal digital assistant (PDA), a portable android device (PAD), a portable media player (PMP), a vehicle-mounted terminal (e.g., a vehicle-mounted navigation terminal), and a fixed terminal such as a digital TV and a desktop computer. The electronic device shown in FIG. 9 is merely an example, and shall not impose any limitation on the functions and use scope of the embodiments of the present disclosure.

As shown in FIG. 9, the electronic device 900 can include a processing apparatus (e.g., a central processing unit, a graphics processor, or the like) 901, which can perform various appropriate actions and processes in accordance with a program stored in a read only memory (ROM) 902 or loaded from a storage apparatus 908 into a random access memory (RAM) 903. In the RAM 903, various programs and data required for the operation of the electronic device 900 are also stored. The processing apparatus 901, the ROM 902, and the RAM 903 are connected to each other through a bus 904. An input/output (I/O) interface 905 is also connected to the bus 904.

In general, the following apparatuses may be connected to the I/O interface 905: an input apparatus 906 including, for example, a touch screen, a touch pad, a keyboard, a mouse, a camera, a microphone, an accelerometer, a gyroscope, etc.; an output apparatus 907 including, for example, a liquid crystal display (LCD), a speaker, a vibrator, etc.; a storage apparatus 908 including, for example, a magnetic tape, a hard disk, etc.; and a communication apparatus 909. The communication apparatus 909 can enable the electronic device 900 to communicate wirelessly or in a wired manner with other devices to exchange data. While FIG. 9 illustrates an electronic device 900 with various apparatuses, it should be understood that it is not required that all of the illustrated apparatuses be implemented or provided. More or fewer apparatuses can alternatively be implemented or provided.

In particular, according to an embodiment of the present disclosure, the process described above with reference to the flowchart can be implemented as a computer software program. For example, an embodiment of the present disclosure includes a computer program product, including a computer program carried on a computer readable medium, where the computer program includes a program code for performing the method as shown in the flowchart. In such an embodiment, the computer program can be downloaded and installed from a network via the communication apparatus 909, or installed from the storage apparatus 908, or installed from the ROM 902. When the computer program is executed by the processing apparatus 901, the above-described functions defined in the method of embodiments of the present disclosure are executed.

An embodiment of the present disclosure also provide a computer program product including a computer program, where when the computer program is executed by a processor, the video processing method above is implemented.

It should be noted that the computer readable medium above in the present disclosure can be a computer readable signal medium or a computer readable storage medium, or a combination thereof. A computer readable storage medium may be, for example, but not limited to, an electronic, a magnetic, an optical, an electromagnetic, an infrared, or a semiconductor system, apparatus or device, or any combination of the foregoing. More specific examples of the computer readable storage medium may include, but are not limited to, an electrical connection having one or more wires, a portable computer diskette, a hard disk, a random access memory (RAM), read-only memory (ROM), an erasable programmable read-only memory (Erasable Programmable ROM, EPROM or Flash Memory), an optical fiber, a portable compact disk read-only memory (Compact Disc ROM, CD-ROM), an optical storage device, a magnetic storage device, or any suitable combination of the foregoing. In the present disclosure, a computer readable storage medium may be any tangible medium that can contain or store a program for use by or in connection with an instruction execution system, apparatus, or device. Furthermore, in the present disclosure, the computer readable signal medium may include a propagated data signal, which carries a computer readable program code, in baseband or as part of a carrier wave. Such a propagated signal may take any of a variety of forms, including, but not limited to, electromagnetic signals, optical signals, or any suitable combination of the foregoing. A computer readable signal medium may also be any computer readable medium other than a computer readable storage medium, which can send, propagate, or transmit a program for use by or in connection with an instruction execution system, apparatus, or device. The program code contained on the computer readable medium may be transmitted by means of any appropriate medium, including, but not limited to, wires, optical fiber cables, radio frequency (RF), etc., or any suitable combination of the foregoing.

The computer readable medium may be contained in the electronic device, or may exist separately without being assembled into the electronic device.

The computer readable medium carries one or more programs which, when executed by the electronic device, cause the electronic device to execute the method shown in the foregoing embodiments.

The computer program code for executing the operations of the present disclosure may be written in one or more programming languages or combinations thereof, and the programming language includes an object-oriented programming language—such as Java, Smalltalk, C++, and also includes a conventional procedural programming language—such as a “C” language or similar programming language. The program code can be entirely executed on the user's computer, partially executed on the user's computer, executed as a stand-alone software package, partially executed on the user's computer and partially executed on a remote computer, or entirely executed on a remote computer or a serve. In situations involving a remote computers, the remote computer can be connected to the user's computer through any type of network, including a local area network (LAN) or wide area network (WAN), or can be connected to an external computer (for example, through the Internet using an Internet Service Provider).

The flowcharts and the block diagrams in the drawings illustrate the architectures, functions, and operations of possible implementations of systems, methods and computer program products according to various embodiments of the present disclosure. In this regard, each block in the flowcharts or block diagrams may represent a module, a program segment, or a part of code, which includes one or more executable instructions for implementing the specified logical functions. It should also be noted that in some alternative implementations, the functions indicated in the blocks may also occur in a different order than those indicated in the drawings. For example, two consecutive blocks can be actually executed in parallel, and sometimes they can also be executed in a reverse order, depending on the function involved. It should also be noted that each block in the block diagrams and/or the flowcharts, and combinations of blocks in the block diagrams and/or flowcharts, can be implemented by means of dedicated hardware-based systems that perform specified functions or operations, or be implemented by means of combinations of dedicated hardware and computer instructions.

A unit involved in the embodiments of the present disclosure may be implemented through software or hardware. The name of the unit does not constitute a limitation to the unit itself in some cases, for example, the first acquisition unit may also be described as “a unit acquiring at least two Internet protocol addresses”.

The functions described herein above may be performed, at least in part, by one or more hardware logic components. For example, without limitation, exemplary types of hardware logic components that can be used include a field-programmable gate array (FPGA), an application specific integrated circuit (ASIC), an application specific standard product (ASSP), a system on chip (SOC), a complex programmable logic device (CPLD), etc.

In the context of the present disclosure, the machine readable medium can be a tangible medium that can contain or store a program for use by or in combination with an instruction execution system, apparatus, or device. The machine readable medium can be a machine readable signal medium or a machine readable storage medium. The machine readable medium may include, but is not limited to, an electronic, a magnetic, an optical, an electromagnetic, an infrared, or a semiconductor system, apparatus, or device, or any suitable combination of the foregoing. More specific examples of the machine readable storage medium may include an electrical connection based on one or more wires, a portable computer diskette, a hard disk, a random access memory (RAM), a read-only memory (ROM), an erasable programmable read-only memory (EPROM or Flash Memory), an optical fiber, a portable compact disk read-only memory (CD-ROM), an optical storage device, a magnetic storage device, or any suitable combination of the foregoing.

In a first aspect, one or more embodiments of the present disclosure provides a video processing method, where the method includes:
acquiring a first video frame to be processed;
segment the first video frame to acquire a patch corresponding to a target object and a patch region;
acquiring position information of three-dimensional points within the patch region, and determining, according to the position information of the three-dimensional points within the patch region, three-dimensional position information of the patch;
displaying, based on the three-dimensional position information of the patch, the patch at a position corresponding to at least one second video frame.

According to one or more embodiments of the present disclosure, the determining, according to the position information of the three-dimensional points within the patch region, three-dimensional position information of the patch includes:
acquiring position information of a target point corresponding to the patch region;
determining, according to the position information of each of the three-dimensional points within the patch region, a depth corresponding to the patch;
determining, according to the depth and the position information of the target point, three-dimensional position information of the patch.

According to one or more embodiments of the present disclosure, the three-dimensional position information of the patch is three-dimensional position information in a world coordinate system;
the determining, according to the depth and the position information of the target point, the three-dimensional position information of the patch includes:
acquiring a camera pose, and determining, according to the depth, the position information of the target point and the camera pose, three-dimensional position information of the patch in the world coordinate system.

According to one or more embodiments of the present disclosure, the determining, according to the depth, the position information of the target point and the camera pose, the three-dimensional position information of the patch in the world coordinate system includes:
determining, according to the depth and the position information of the target point, first three-dimensional position information corresponding to the target point, where the first three-dimensional position information corresponding to the target point is three-dimensional position information of the target point in a camera coordinate system;
converting, according to the camera pose, the first three-dimensional position information of the target point to obtain second three-dimensional position information corresponding to the target point, where the second three-dimensional position information corresponding to the target point is three-dimensional position information of the target point in the world coordinate system;
taking the second three-dimensional position information corresponding to the target point as the three-dimensional position information of the patch in the world coordinate system.

According to one or more embodiments of the present disclosure, the position information of the three-dimensional points includes depths corresponding to the three-dimensional points;
the determining, according to the position information of each of the three-dimensional points within the patch region, the depth corresponding to the patch includes:
performing statistical processing on the depth corresponding to each of the three-dimensional points within the patch region to obtain the depth corresponding to the patch.

According to one or more embodiments of the present disclosure, the performing the statistical processing on the depth corresponding to each of the three-dimensional points within the patch region to obtain the depth corresponding to the patch includes:
acquiring a median of depths corresponding to the three-dimensional points within the patch region, and determining the median as the depth corresponding to the patch;
or,
acquiring a mode of depths corresponding to the three-dimensional points within the patch region, and determining the mode as the depth corresponding to the patch;
or,
acquiring an average value of depths corresponding to the three-dimensional points within the patch region, and determining the average value as the depth corresponding to the patch.

According to one or more embodiments of the present disclosure, the displaying, based on the three-dimensional position information of the patch, the patch at the position corresponding to at least one second video frame includes:
acquiring a direction of the patch;
displaying, based on the three-dimensional position information of the patch and the direction of the patch, the patch at a position corresponding to at least one second video frame.

According to one or more embodiments of the present disclosure, the acquiring the position information of the three-dimensional points within the patch region includes:
determining, based on a simultaneous localization and mapping construction algorithm, position information of spatial three-dimensional points in the first video frame and each of the spatial three-dimensional points;
determining, according to the position information of the spatial three-dimensional points, spatial three-dimensional points within the patch region from the spatial three-dimensional points;
taking the position information of the spatial three-dimensional points within the patch region as the position information of the three-dimensional points within the patch region.

According to one or more embodiments of the present disclosure, the method further includes:
determining, based on a simultaneous localization and mapping construction algorithm, a camera pose corresponding to the first video frame.

According to one or more embodiments of the present disclosure, the acquiring the first video frame to be processed includes:
acquiring the first video frame in response to a triggering operation acting on a screen of an electronic device;
and/or,
acquiring the first video frame when detecting that the target object is in a static state,
and/or,
acquiring the first video frame at a preset interval.

In a second aspect, one or more embodiments of the present disclosure provides a video processing device, where the device includes:
an information acquisition module, configured to acquire a first video frame to be processed;
a processing module, configured to segment the first video frame to acquire a patch corresponding to a target object and a patch region;
where the processing module is configured to acquire position information of three-dimensional points within the patch region, and determine, according to the position information of the three-dimensional points within the patch region, three-dimensional position information of the patch;
a displaying module, configured to display, based on the three-dimensional position information of the patch, the patch at a position corresponding to at least one second video frame.

According to one or more embodiments of the present disclosure, the processing module is further configured to:
acquire position information of a target point corresponding to the patch region;
determine, according to the position information of each of the three-dimensional points within the patch region, a depth corresponding to the patch;
determine, according to the depth and the position information of the target point, three-dimensional position information of the patch.

According to one or more embodiments of the present disclosure, the three-dimensional position information of the patch is three-dimensional position information in a world coordinate system;

the processing module is further configured to:

acquire a camera pose, and determine, according to the depth, the position information of the target point and the camera pose, three-dimensional position information of the patch in the world coordinate system.

According to one or more embodiments of the present disclosure, the processing module is further configured to:
determine, according to the depth and the position information of the target point, first three-dimensional position information corresponding to the target point, where the first three-dimensional position information corresponding to the target point is three-dimensional position information of the target point in a camera coordinate system;
convert, according to the camera pose, the first three-dimensional position information of the target point to obtain second three-dimensional position information corresponding to the target point, where the second three-dimensional position information corresponding to the target point is three-dimensional position information of the target point in the world coordinate system;
take the second three-dimensional position information corresponding to the target point as the three-dimensional position information of the patch in the world coordinate system.

According to one or more embodiments of the present disclosure, the position information of the three-dimensional points includes depths corresponding to the three-dimensional points;
the processing module is further configured to:
perform statistical processing on the depth corresponding to each of the three-dimensional points within the patch region to obtain the depth corresponding to the patch.

According to one or more embodiments of the present disclosure, the processing module is further configured to: acquire a median of depths corresponding to the three-dimensional points within the patch region, and determining the median as the depth corresponding to the patch;
or,
acquire a mode of depths corresponding to the three-dimensional points within the patch region, and determine the mode as the depth corresponding to the patch;
or,
acquire an average value of depths corresponding to the three-dimensional points within the patch region, and determine the average value as the depth corresponding to the patch.

According to one or more embodiments of the present disclosure, the displaying module is further configured to:
acquire a direction of the patch;
display, based on the three-dimensional position information of the patch and the direction of the patch, the patch at a position corresponding to at least one second video frame.

According to one or more embodiments of the present disclosure, the processing module is further configured to: determine, based on a simultaneous localization and mapping construction algorithm, position information of spatial three-dimensional points in the first video frame and each of the spatial three-dimensional points;
determine, according to the position information of the spatial three-dimensional points, spatial three-dimensional points within the patch region from the spatial three-dimensional points;
take the position information of the spatial three-dimensional points within the patch region as the position information of the three-dimensional points within the patch region.

According to one or more embodiments of the present disclosure, the processing module is further configured to:
determine, based on a simultaneous localization and mapping construction algorithm, a camera pose corresponding to the first video frame.

According to one or more embodiments of the present disclosure, the information acquisition module is further configured to:
acquire the first video frame in response to a triggering operation acting on a screen of an electronic device;
and/or,
acquire the first video frame when detecting that the target object is in a static state,
and/or,
acquire the first video frame at a preset interval.

In a third aspect, one or more embodiments of the present disclosure provides an electronic device, where the electronic device includes at least one processor and a memory;
where the memory stores computer execution instructions;
the at least one processor executes the computer execution instructions, causing the at least one processor to perform the video processing method of the first aspect and various possible designs of the first aspect.

In a fourth aspect, one or more embodiments of the present disclosure provides a computer readable storage medium, where the computer readable storage medium stores therein computer execution instructions, when the computer execution instructions are executed by a processor, the video processing method of the first aspect and various possible designs of the first aspect is implemented.

In a fifth aspect, one or more embodiments of the present disclosure provides a computer program product including a computer program, where when the computer program is executed by a processor, the video processing method of the first aspect and various possible designs of the first aspect is implemented.

In a sixth aspect, one or more embodiments of the present disclosure provides a computer program, where when the computer program is executed by a processor, the video processing method of the first aspect and various possible designs of the first aspect is implemented.

The above description is merely illustrative of the preferred embodiments of the present disclosure and of the technical principles employed. A person skilled in the art should understand that the scope involved in the present disclosure is not limited to the technical solution formed by the specific combination of the above technical features, and should also cover other technical solutions formed by any combination of the above technical features or equivalent features thereof without departing from the above concept, for example, a technical solution is formed by replacing the above features with technical features having similar functions disclosed in the present disclosure (but not limited thereto).

In addition, while operations are depicted in a particular order, this should not be understood as requiring that the operations be performed in the particular order shown or in a sequential order. In certain environments, multitasking and parallel processing may be advantageous. Likewise, while several specific implementation details are included in the above discussion, these should not be construed as limiting the scope of the present disclosure. Some features described in the context of individual embodiments can also be implemented in combination in a single embodiment. Conversely, various features described in the context of a single embodiment can also be implemented individually or in any suitable sub-combination in multiple embodiments.

Although the subject matter has been described in language specific to structural features and/or method logical actions, it should be understood that the subject matter defined in the appended claims is not necessarily limited to the specific features or actions described above. Rather, the specific features and actions described above are merely exemplary forms of implementing the claims.

What is claimed is:

1. A video processing method, comprising:
acquiring a first video frame to be processed;
segmenting the first video frame to acquire a patch corresponding to a target object and a patch region;
acquiring position information of three-dimensional points within the patch region, and determining, according to the position information of the three-dimensional points within the patch region, three-dimensional position information of the patch;
displaying, based on the three-dimensional position information of the patch, the patch at a position corresponding to at least one second video frame.

2. The method according to claim 1, wherein the determining, according to the position information of the three-dimensional points within the patch region, three-dimensional position information of the patch comprises:
acquiring position information of a target point corresponding to the patch region;
determining, according to the position information of each of the three-dimensional points within the patch region, a depth corresponding to the patch;
determining, according to the depth and the position information of the target point, three-dimensional position information of the patch.

3. The method according to claim 2, wherein the three-dimensional position information of the patch is three-dimensional position information in a world coordinate system;
the determining, according to the depth and the position information of the target point, the three-dimensional position information of the patch comprises:
acquiring a camera pose, and determining, according to the depth, the position information of the target point and the camera pose, three-dimensional position information of the patch in the world coordinate system.

4. The method according to claim 3, wherein the determining, according to the depth, the position information of the target point and the camera pose, the three-dimensional position information of the patch in the world coordinate system comprises:
determining, according to the depth and the position information of the target point, first three-dimensional position information corresponding to the target point, wherein the first three-dimensional position information corresponding to the target point is three-dimensional position information of the target point in a camera coordinate system;
converting, according to the camera pose, the first three-dimensional position information of the target point to obtain second three-dimensional position information corresponding to the target point, wherein the second three-dimensional position information corresponding to the target point is three-dimensional position information of the target point in the world coordinate system;
taking the second three-dimensional position information corresponding to the target point as the three-dimensional position information of the patch in the world coordinate system.

5. The method according to claim 2, wherein the position information of the three-dimensional points comprises depths corresponding to the three-dimensional points;
the determining, according to the position information of each of the three-dimensional points within the patch region, the depth corresponding to the patch comprises:
performing statistical processing on the depth corresponding to each of the three-dimensional points within the patch region to obtain the depth corresponding to the patch.

6. The method according to claim 5, wherein the performing the statistical processing on the depth corresponding to each of the three-dimensional points within the patch region to obtain the depth corresponding to the patch comprises:
acquiring a median of depths corresponding to the three-dimensional points within the patch region, and determining the median as the depth corresponding to the patch;
or,
acquiring a mode of depths corresponding to the three-dimensional points within the patch region, and determining the mode as the depth corresponding to the patch;
or,
acquiring an average value of depths corresponding to the three-dimensional points within the patch region, and determining the average value as the depth corresponding to the patch.

7. The method according to claim 1, wherein the displaying the patch at a position corresponding to at least one second video frame comprises:
acquiring a direction of the patch;
displaying, based on the three-dimensional position information of the patch and the direction of the patch, the patch at a position corresponding to at least one second video frame.

8. The method according to claim 1, wherein the acquiring the position information of the three-dimensional points within the patch region comprises:
determining, based on a simultaneous localization and mapping construction algorithm, position information of spatial three-dimensional points in the first video frame and each of the spatial three-dimensional points;
determining, according to the position information of the spatial three-dimensional points, spatial three-dimensional points within the patch region from the spatial three-dimensional points;
taking the position information of the spatial three-dimensional points within the patch region as the position information of the three-dimensional points within the patch region.

9. The method according to claim 1, wherein the method further comprises:
determining, based on a simultaneous localization and mapping construction algorithm, a camera pose corresponding to the first video frame.

10. The method according to claim 1, wherein the acquiring the first video frame to be processed comprises:
acquiring the first video frame in response to a triggering operation acting on a screen of an electronic device;
and/or,
acquiring the first video frame when detecting that the target object is in a static state,
and/or,
acquiring the first video frame at a preset interval.

11. (canceled)

12. A video processing device, comprising: at least one processor and a memory;
wherein the memory stores computer execution instructions;
the at least one processor executes the computer execution instructions, causing the at least one processor to;
acquire a first video frame to be processed;
segment the first video frame to acquire a patch corresponding to a target object and a patch region;
acquire position information of three-dimensional points within the patch region, and determine, according to the position information of the three-dimensional points within the patch region, three-dimensional position information of the patch;
display, based on the three-dimensional position information of the patch, the patch at a position corresponding to at least one second video frame.

13. A non-transitory computer readable storage medium, wherein the computer readable storage medium stores therein computer execution instructions, when the computer execution instructions are executed by a processor, the following is implemented:
acquiring a first video frame to be processed;
segmenting the first video frame to acquire a patch corresponding to a target object and a patch region;
acquiring position information of three-dimensional points within the patch region, and determining, according to the position information of the three-dimensional points within the patch region, three-dimensional position information of the patch;
displaying, based on the three-dimensional position information of the patch, the patch at a position corresponding to at least one second video frame.

14-15. (canceled)

16. The device according to claim 12, wherein the at least one processor is further caused to:
acquire position information of a target point corresponding to the patch region;
determine, according to the position information of each of the three-dimensional points within the patch region, a depth corresponding to the patch;
determine, according to the depth and the position information of the target point, three-dimensional position information of the patch.

17. The device according to claim 16, wherein the three-dimensional position information of the patch is three-dimensional position information in a world coordinate system;
wherein the at least one processor is further caused to:
acquire a camera pose, and determine, according to the depth, the position information of the target point and the camera pose, three-dimensional position information of the patch in the world coordinate system.

18. The device according to claim 17, wherein the at least one processor is further caused to:
determine, according to the depth and the position information of the target point, first three-dimensional position information corresponding to the target point, wherein the first three-dimensional position information corresponding to the target point is three-dimensional position information of the target point in a camera coordinate system;
convert, according to the camera pose, the first three-dimensional position information of the target point to obtain second three-dimensional position information corresponding to the target point, wherein the second three-dimensional position information corresponding to the target point is three-dimensional position information of the target point in the world coordinate system;
take the second three-dimensional position information corresponding to the target point as the three-dimensional position information of the patch in the world coordinate system.

19. The device according to claim 16, wherein the position information of the three-dimensional points comprises depths corresponding to the three-dimensional points;
wherein the at least one processor is further caused to:
perform statistical processing on the depth corresponding to each of the three-dimensional points within the patch region to obtain the depth corresponding to the patch.

20. The device according to claim 19, wherein the at least one processor is further caused to:
acquire a median of depths corresponding to the three-dimensional points within the patch region, and determine the median as the depth corresponding to the patch;
or,
acquire a mode of depths corresponding to the three-dimensional points within the patch region, and determine the mode as the depth corresponding to the patch;
or,
acquire an average value of depths corresponding to the three-dimensional points within the patch region, and determine the average value as the depth corresponding to the patch.

21. The device according to claim 12, wherein the at least one processor is further caused to:
acquire a direction of the patch;
display, based on the three-dimensional position information of the patch and the direction of the patch, the patch at a position corresponding to at least one second video frame.

22. The device according to claim 12, wherein the at least one processor is further caused to:
determine, based on a simultaneous localization and mapping construction algorithm, position information of spatial three-dimensional points in the first video frame and each of the spatial three-dimensional points;
determine, according to the position information of the spatial three-dimensional points, spatial three-dimensional points within the patch region from the spatial three-dimensional points;
take the position information of the spatial three-dimensional points within the patch region as the position information of the three-dimensional points within the patch region.

23. The device according to claim 12, wherein the at least one processor is further caused to:
determine, based on a simultaneous localization and mapping construction algorithm, a camera pose corresponding to the first video frame.
